(19) United States
(12) Patent Application Publication
(10) Pub. No.: US 2002/0104393 A1
(43) Pub. Date: Aug. 8, 2002

(54) Variable moment vibrator

(76) Inventors: J. R. Van Es, Holland (NL); J. A. Bomer, Holland (NL)

Correspondence Address: Richard C. Litman, LITMAN LAW OFFICES, LTD., P.O. Box 15035, Arlington, VA, 22215, US

(21) Appl. No.: 09/777,663

(22) Filed: Feb. 7, 2001

(51) Int. Cl. F16H 33/10

(52) U.S. Cl. 74/87

(57) ABSTRACT

An improved variable moment vibratory driver system in which a variable moment is achieved by hydraulically shifting the phase of two sets of eccentric weights via a control valve shifter. The mutual phase of the two sets may be changed at any time without stopping the gear wheel rotation unprecedented in conventional devices. The weights are shifted through direct driven meshed gear links which are located in the place of Pecqueur epycyclic gears. An integral electrical wire diagram of the control valve shifter and a hydraulic phase shifter are used to start and stop the variable moment vibrator with reduced gear elements and virtually no vibration.

### BACKGROUND OF THE INVENTION

1. Field of the Invention

The present invention relates generally to the field of vibratory element drivers. More specifically, the invention is an improved variable moment vibratory driver in which a variable moment is achieved by hydraulically shifting the phase of two sets of eccentric weights.

2. Description of the Related Art

Numerous vibratory devices have been devised having phase shifting features. Most conventional vibratory machines utilize twin sets of eccentric weights in order to obtain or maintain vibration of an apparatus, particularly along an axis called the functional axis. It has been seen in conventional vibratory machinery, that if two wheels within a gear system rotate in perfect synchronism and if each eccentric mass is fixed on the two wheels in such a way to be at each instant symmetrical in relation to one another with respect to the other along the so called “functional axis”, centrifugal forces having components parallel thereto become ineffective vibratory elements and resolved transverse components acting or joining the centers cancel each other. In effect, vibrating forces acting on these conventional devices are made to be unidirectional with sinusoidal behavior which produces amplitudes attributed to mechanical failure and cyclical wear. This vibratory behavior in whole, is the sum total or superposition of such amplitudes produced by the various vibratory elements which includes servo-motors, belt drive systems and/or vibration behavior inherent in start and stop operations, including flux jump or similar effects. Unlike conventional vibratory devices, the variable moment vibrator as herein described reduces vibration behavior by minimizing mechanical parts such as gears or gear systems particularly where Pecqueur epicycloidal trains have been required. This particular feature is unprecedented among conventional vibratory machines.

For example, U.S. Pat. No. 3,564,932 issued to Lebelle discloses vibrodriver system comprising at least two sets of eccentric weights which are mounted to wheels through a Pecqueur epicycloidal train. The variable moment vibrator according to the invention alleviates the use of the Pecqueur epicycloidal train.

U.S. Pat. No. 3,813,950 issued to Elbersole discloses an apparatus for producing a variable amplitude vibratory force which is particularly useful as a rotatable eccentric for a vibratory roller. The rotatable eccentric includes a first and second eccentric fluid chamber rotatable about a common axis of rotation, and an adjustable valve interconnecting the chambers for controlling the amount of fluid transfer between the chambers upon rotation of the eccentric to produce a variable amplitude vibratory force.

U.S. Pat. No. 3,837,231 issued to Holmlund discloses a vibrator for generating directional vibrations comprising a pair of bodies rotatable eccentrically about respective mutually parallel axes in opposite directions and gears associated with the eccentrically rotatable bodies meshing to provide counter-rotation of the bodies. The drive arrangement selectively drives the bodies in rotation in either of two distinct and separate phase relationships. One of the rotatable bodies is rotatable relative to the gear associated with it, and matching abutments on that body and gear are mutually engageable to transmit driving between them in two different angularly spaced-apart positions of the rotatable body, relative to the associated gears. A belt drive having a shifting mechanism is arranged to transmit rotational power either to the body or the gear of the relatively rotatable body and gear components.

U.S. Pat. No. 4,262,549 issued to Schwellenbach discloses a variable mechanical vibrator comprising a first and second eccentric weight fixed to a rotatably mounted shaft wherein the two weights are rotated together under control of mating engagement abutments, one carried by the shaft and one carried or having a surface of the second eccentric weight. First and second prime movers are used to rotate the shaft and the second eccentric weight, respectively. When primary rotation of the shaft is effected by a first prime mover, the first and second eccentric weights are diametrically oppositely aligned with respect to one another on the shaft providing a balanced operation. A second mode of operation is effected under control of the second prime mover which rotates the second eccentric weight to a point where the engagement abutments engage one another in a position where the first and second eccentric weights are aligned with one another on the shaft which creates an unbalanced condition.

U.S. Pat. No. 4,289,042 issued to Brown discloses a vibrator with eccentric weights mounted on two coaxial shafts, respectively. The two shafts are adapted to rotate in unison or separately for relative motion which alters the angular relationship between the weights while both shafts continue to rotate. Beveled gear trains are used to rotate the two shafts at one end of the vibrator. By changing the angular relationship between the gears at the other end of the gear trains, the angular relationship between the eccentric weights, and hence the stroke of the vibrator can be changed.

U.S. Pat. No. 4,356,736 issued to Riedl discloses an imbalance oscillation exciter having two imbalance weights arranged on each of two axially parallel or coaxial imbalance-weight carriers positively rotatably coupled with one another and rotating counter to each other in the same direction. One of the imbalance-weight carriers comprises a shaft, whereby the imbalance-weight carriers are coupled with each other by a hub for continuous opposite rotation which allows for changing the phase position of the imbalance weights.

A pin fixed on the shaft slidably engages in a hub groove. The pin is shiftable along a shaft slot extending at an incline to the hub groove by means of an adjustment member arranged coaxially in the shaft. The shaft has an axially parallel cylinder chamber open toward one of its end faces and in which the adjustment member is slidable with a piston extension sealed with respect thereto and facing the open side of the cylinder chamber. A pressure medium or fluid is supplied by way of a fluid chamber fixed in the housing and sealingly surrounding the shaft. Riedl discloses another vibrator in U.S. Pat. No. 5,010,778 which includes two axially parallel, interlocking and counter rotating unbalanced shafts. Both the phase relationship of the unbalanced shafts, and hence the direction the vector of the directed vibrations is variable. Similarly, the unbalanced shafts are coupled via a hub that is disposed in a rotatable yet axially fixed manner.

U.S. Pat. No. 4,617,832 issued to Musschoot discloses a vibratory apparatus having a variable lead angle and force which positions a movable weight relative to a fixed eccentric weight. The apparatus comprises a plate supporting the fixed eccentric weight on the shaft in one of several positions with a line through the center of gravity of the fixed weight and the axis of the shaft which forms a base line. The movable weight is carried by a cylinder attached to the plate so that the longitudinal axis of the cylinder passes through the axis of the shaft at an angle to the base line. The movable weight in the cylinder is spring loaded and movable from a position on one side of the axis of rotation wherein the movement is linear and radially across the axis of rotation.

U.S. Pat. No. 5,253,542 issued to Houze discloses a variable moment vibrator usable for driving objects into the ground. The vibrator has two series of eccentric weights each comprising at least two weights turning in opposite directions and at least one motor coupled to a first series of weights by gearing and to a second series of weights by a transmission device which includes a phase shifter in the form of two coaxial shafts. Each shaft comprises helical teeth and an annular piston which slides between the two shafts, delimiting therewith at least one working chamber into which a pressurized fluid is injected. The piston has helical teeth meshing with those on the two shafts.

Foreign patents granted to Bahr et al. (DE 2847165), Sautereau (DE 2847165), Baumers (EP 0070344), Oota (JP 5977145), Krauinshp (SU 1260041), Krymniiproekt (SU 1577875) and Shimada (JP 5 237459) teach conventional vibratory features which depict mechanical vibrator systems utilizing twin out of balance shafts with counterbalance devices to change the phase relationship of out-of-balance forces thereto. These particular features are considered to be of general relevance to the variable moment vibrator as herein described.

The Soviet Union Patent granted to Khark (SU 1428479) discloses a vibratory machine which has hydrocylinders with pistons and main elastic chambers connected to a compressed gas source including coaxially situated elastic chambers which are connected to a hydraulic pump for maintaining reciprocating motion via a piston.

A vibro-exciter disclosed in the patent granted to Sibe (SU 1516147) operates based on similar vibration principles wherein debalancing is performed by a ring and slot assembly.

None of the above inventions and patents, taken either singularly or in combination, is seen to describe the instant invention as claimed. Thus a variable moment vibrator solving the aforementioned problems is desired.

### SUMMARY OF THE INVENTION

The improved variable moment vibratory driver according to the invention produces a variable moment which is achieved by hydraulically shifting the phase of two sets of eccentric weights via a control valve shifter. The mutual phase of the two sets may be changed at any time without stopping the gear wheel rotation unprecedented in conventional devices. The weights are shifted through direct driven meshed gear links which are located in the place of Pecqueur epycyclic gears. An integral control valve shifter and a hydraulic phase shifter is described for starting and stopping the variable moment vibrator with virtually no vibration when the eccentric weights are in an opposed or neutral position.

Accordingly, it is a principal object of the invention to provide an improved variable moment vibratory driver which reduces selective vibrations.

It is another object of the invention to provide an improved variable moment vibratory driver which utilizes minimized mechanical gear elements.

It is a further object of the invention to provide an improved variable moment vibratory driver having a control valve shifter and hydraulic phase shifter for selectively stopping and starting the variable moment driver with eccentric weights disposed in a neutral position.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a cut-away view of a hydraulic phase shifter according to the present invention.

FIG. 2A is a diagrammatic view of a conventional variable moment vibrator, illustrating an epicyclic driver arrangement in a mechanism train.

FIG. 2B is an alternate diagrammatic view of the conventional variable moment vibrator, illustrating an epicyclic driver arrangement.

FIG. 3A is a diagrammatic view of the variable moment vibrator according to the invention, illustrating a single intermediate phase.

FIG. 3B is an alternate diagrammatic view of the variable moment vibrator according to the invention, illustrating an epicyclic driver arrangement with reduced mechanical parts.

FIG. 4 is a sectional perspective view of the hydraulic phase shifter according to the invention.

FIG. 5A is a sectional schematic of a control valve shifter according to the invention.

FIG. 5B is a hydraulic diagram of the control valve shifter according to the invention.

FIG. 6 is an integral electrical wire diagram of the control valve shifter and hydraulic phase shifter according to the invention.

FIG. 7 is a perspective view of the variable moment vibrator according to FIG. 3A of the invention, illustrating a single intermediate phase, mounted within a housing assembly.

Similar reference characters denote corresponding features consistently throughout the attached drawings.

### DETAILED DESCRIPTION OF THE PREFERRED EMBODIMENTS

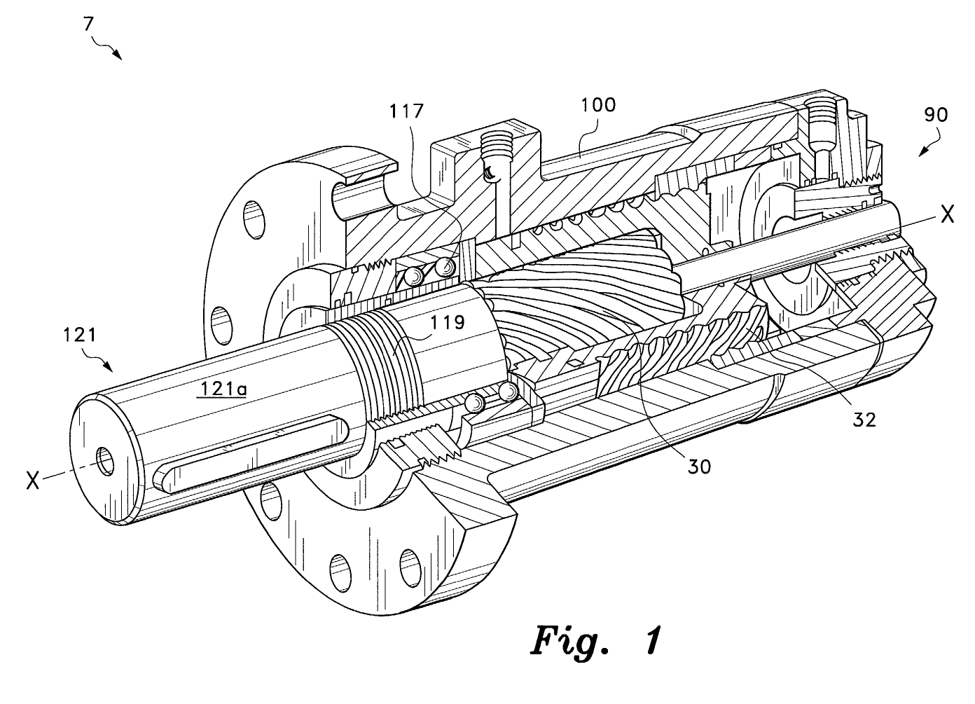

The present invention is directed to an improved variable moment vibrator driver system for driving into ground piles, stakes and posts or similar objects. The preferred embodiments of the present invention are depicted in FIGS. 1-6, and are generally referenced as elements 7, 8 and 9, respectively.

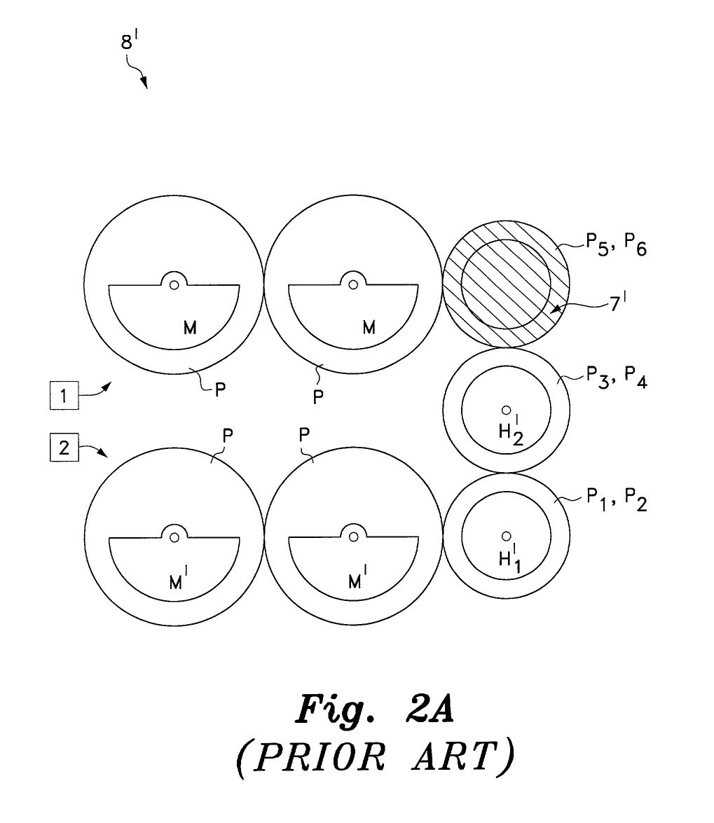

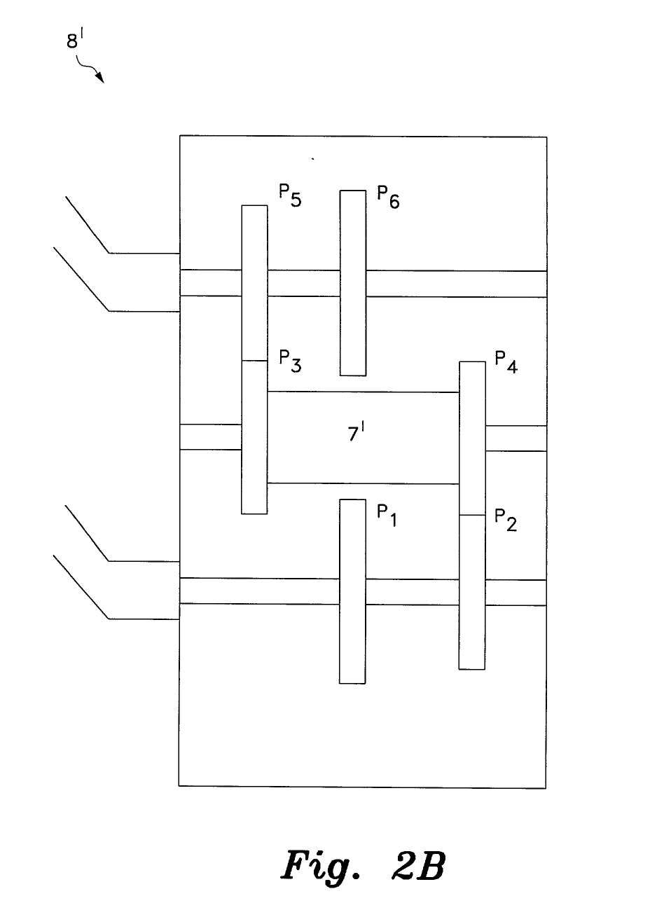

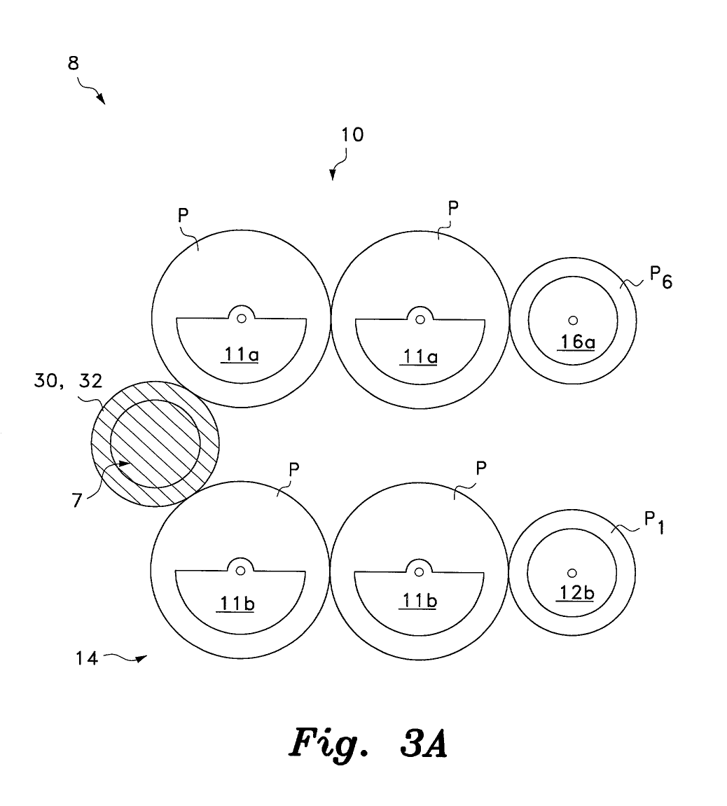

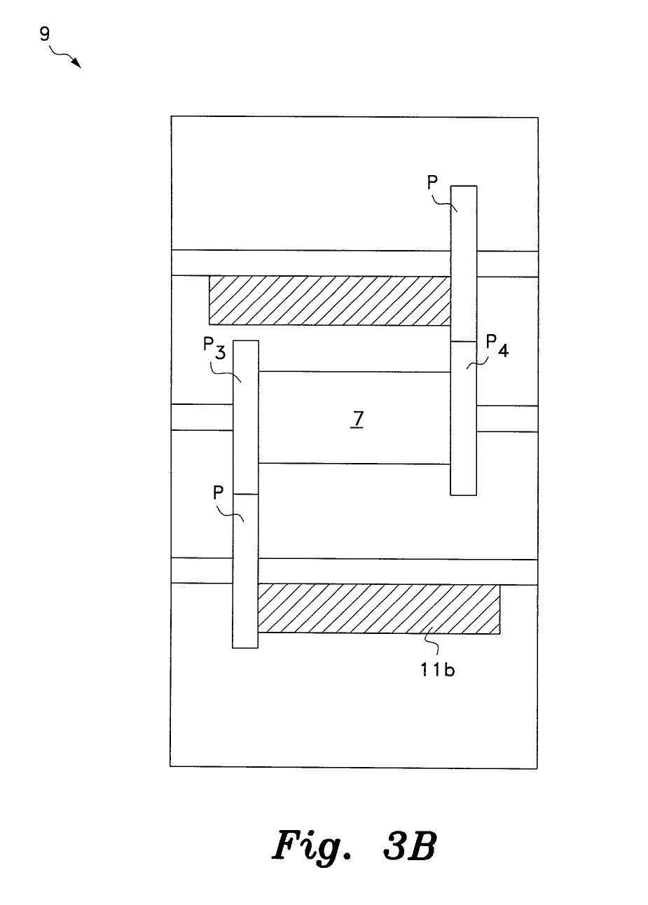

As diagrammatically illustrated in FIGS. 1-3B, a hydraulic phase shifter 7 is shown as an elemental feature of the invention used in comparison with conventional drivers. These drivers utilize an epicyclic driver arrangement in a mechanism train which increase the number of mechanical elements such as gears and/or gear system as illustrated in FIGS. 2A and 2B and further discussed below. According to conventional features, FIG. 2A depicts a vibro-driver system 8′ which utilizes a phase shifter element 7′ mounted in series with two drive motors H₁′ and H₂′ for driving a set of eccentric weighted gears P. This particular system 8′ is widely used and requires the effective use of two extra gear wheels for operation. The phase shifter 7 according to the instant invention serves as a dynamic coupling means for a vibrator driver system 8 comprising a first set of gearwheels 10 having at least one means or gear 12 for driving the first set of gearwheels 10, a second set of gearwheels 14 having at least one other means or gear 16 for driving the second set of gearwheels 14, respectively. The phase shifter 7, unlike conventional features is disposed between a set of eccentric weighted gearwheels P opposed to driver gears P₁ and P₆ as shown in FIG. 3A. This arrangement not only eliminates the need for unnecessary mechanical elements namely superfluous gears, but it also has proven to extend the life of the system 8 by reducing wear and tear on material or mechanical parts P. As shown in FIG. 2B, the conventional vibro-driver system 8′ illustrates the use of two additional gears P₁ and P₆. As with the instant invention, FIG. 3B diagrammatically illustrates the elimination of gears P₁ and P₆ for effective operation of the system 8, wherein the phase shifter 7 is centrally disposed between a set of eccentric weighted gears P. Instead of the conventional arrangement of the required six gears (i.e. P₁-P₆) as required by FIG. 2B, system 8 utilizes gears 12 and 16 (equivalent to gears P₁ and P₆, respectively) as isolated gear drivers for separately driving each respective set of gearwheels 10 and 14.

Accordingly, means 12 and 16 are decoupled gear drivers, and are conventionally mounted with motors designated as elements 12a and 16a. As recited above the phase shifter or coupling means 7 is disposed between the set of gearwheels 10 and 14 for selectively and dynamically coupling the first and second set of gears 10 and 14 thereto. Depending on the dynamic characteristics of the motors attached to each driver 12 and 16, dynamic characteristics of the system will be in direct proportion thereto, including selective phase changes generated by the phase shifter 7.

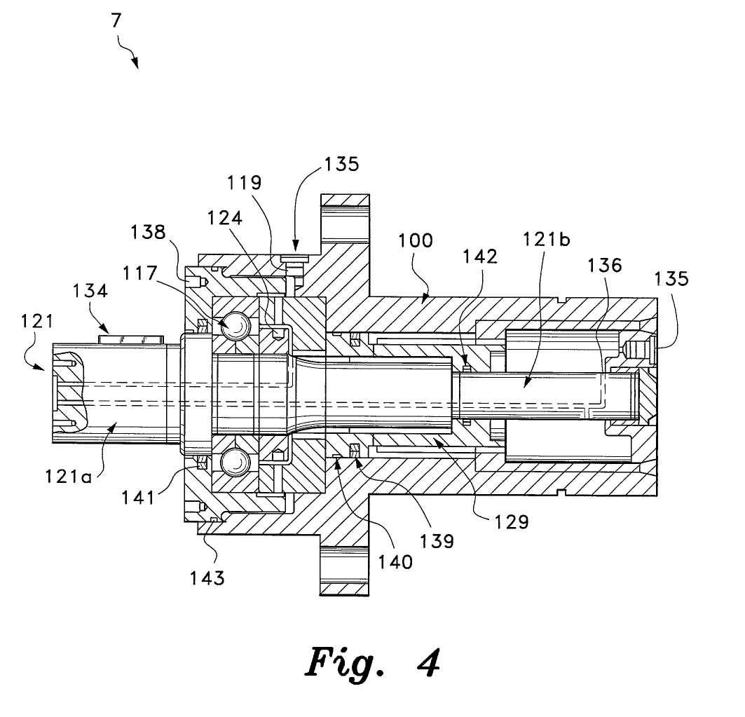

The improvement then is directed to the location of the phase shifter 7 and the dynamic connection with the first and second set of gear wheels 10 and 14 which are each mounted on one eccentric first and second moment 11a and 11b. The respective driver means 12,16 connected in opposite relation thereto constitute a first and second drive gear and motor assembly for driving the respective first and second set of gearwheels 10 and 14. With more particularity, the coupling means or phase shifter 7 comprises a first and second concentric shaft portion 121a and 121b of a shaft 121, wherein the first shaft portion 121a includes an interior gear portion 30 nested within an outer gear portion 32 to form a gear linked mesh. This gear linked mesh serves to selectively rotate the first shaft portion and any attached gears P, P₃, P₄, etc. with respect to a central axis X-X formed through the centroid of the shaft 121. The gear linked mesh controls the change in mutual phase of the two sets of gearwheels 10 and 14 without stopping the gearwheel rotation during operation. The second shaft portion 121b preferably has a smaller diameter than the first shaft portion 121a, and is of solid cylindrical construction. A plurality of peripherally disposed threads 119 are formed along an outer surface of the first shaft portion 121a and covers a predetermined length portion along the first shaft portion 121a for threadedly attaching to a an interior portion 90 of a phase shifter housing 100. Other features of the hydraulic phase shifter 7 are diagrammatically illustrated in FIG. 4.

As shown therein, the phase shifter 7 includes head bearings 117, square bearing ring 119, gear shaft 121, shaft nut 124, piston 129, four point bearing (not shown), featherkey 134, plug screw 135, nozzle 136, fitting pin 139, conic plug screw 138 and a pilot check valve (not shown). Wear parts include conventional piston seals, piston guide bands 140, pivot seals 141, shaft seals 142, O-rings 143 and the like for preventing unwanted fluid leaks.

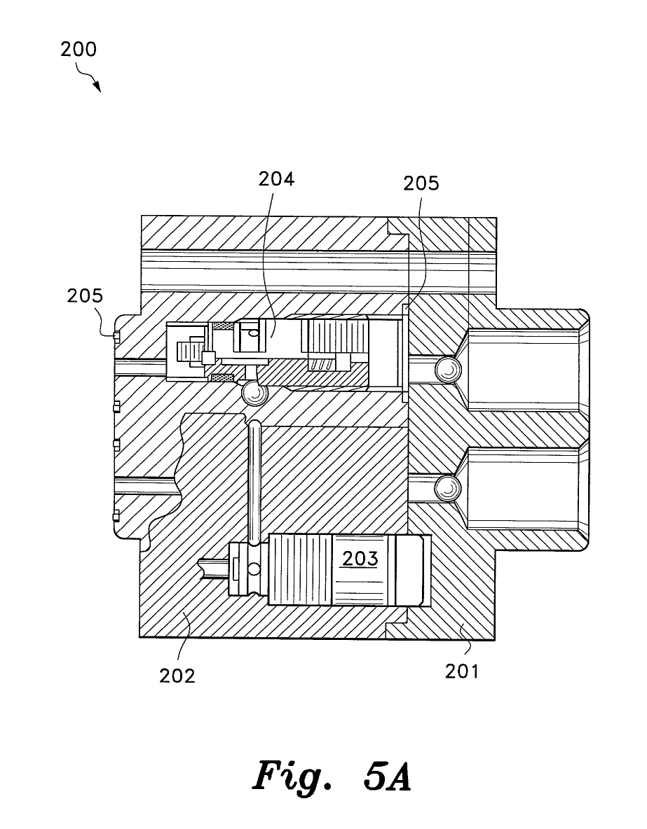

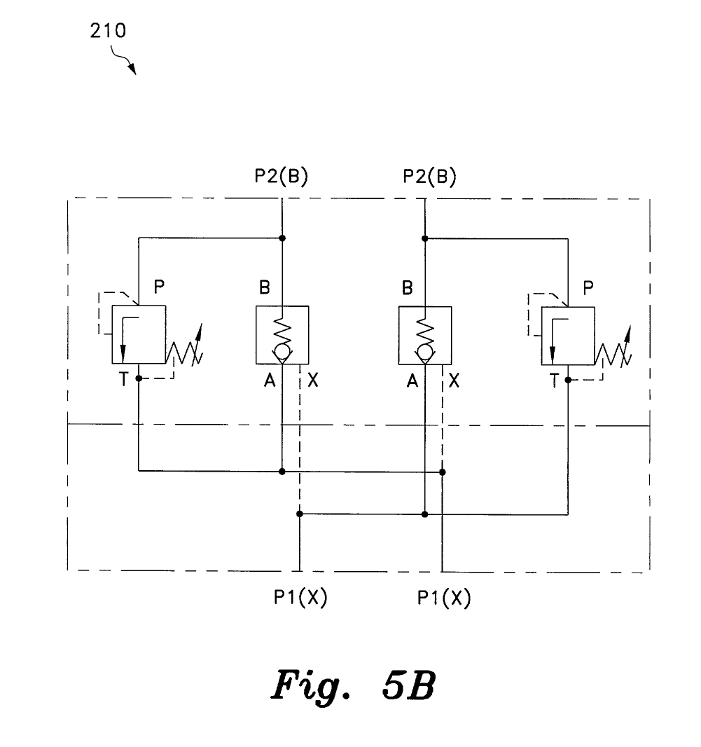

As diagrammatically illustrated in FIG. 5A, a control valve 200 is shown which is disposed on the phase shifter as a hydraulic operated valve 200. As shown therein, the phase shifter 7 comprises a manifold head 201, a manifold block 202, a pressure valve 203, a one way valve 204 and O-rings 205. The control valve has two primary functions as specified below:

1.) The control valve 200 prevents the phase shifter 7 from changing the position of gears P₃ and P₄ during operation. Due to high operating temperatures, the pressure inside the phase shifter 7 changes thereby inducing or effecting a position change in the aforementioned gears in the absence of an installed control valve 200.

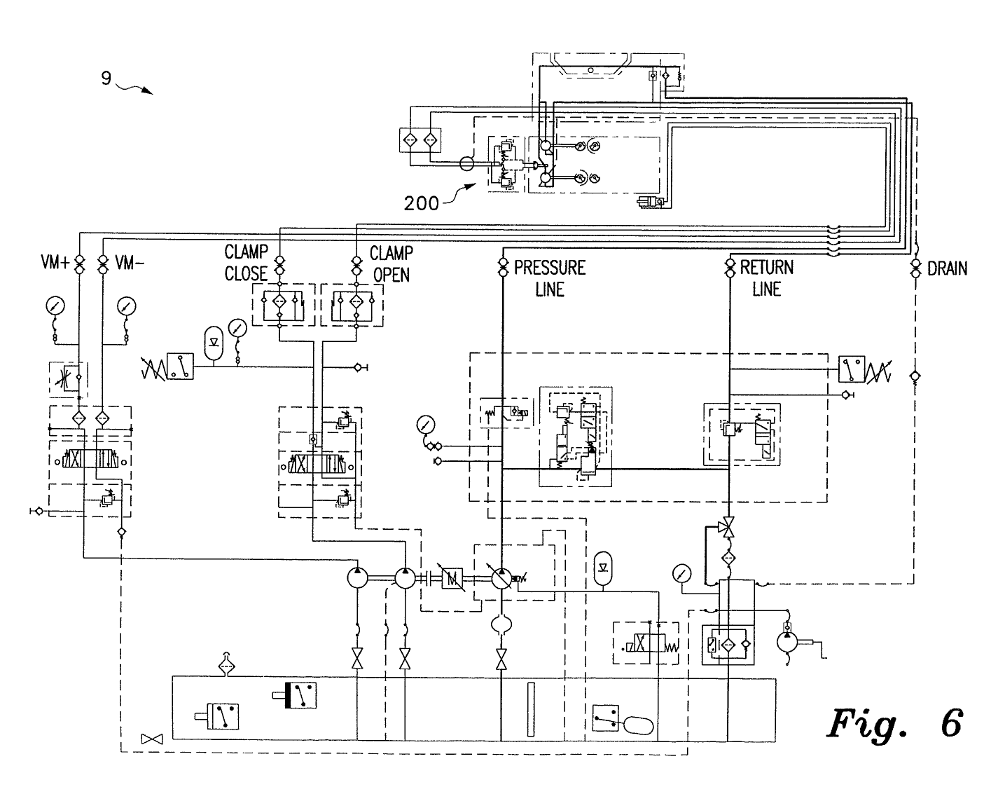

2.) The control valve 200 protects the phase shifter from excessive or critical pressures via a relief valve. The control valve is placed on the shaft 121 of the phase shifter and has two connections P1(B) and P2(B) as illustrated in FIG. 5B as a hydraulic schematic diagram 210 of the control valve 200. P2(B) is connected to one side of the hydraulic piston 129 of the phase shifter 7. P1(B) is connected to the other side of the hydraulic piston 129 in the phase shifter 7. P1(X) and P2(X) are both connected to a hydraulic system which can operate the phase shifter 7. Since hydraulic connections are considered to be well within the knowledge of one having ordinary skill in the art, such features are not discussed in detail. Within the control valve 200, however, two check valves 204 (schematically illustrated as between points B and A in FIG. 5B) are mounted to keep the phase shifter in position. Two pressure relief valves 203 (schematically illustrated as between points P and T in FIG. 5B) are mounted to protect the phase shifter against high or critical pressures which produces system failure. Further details of this particular connection to the phase shifter 7 are shown in FIG. 6 which is a hydraulic diagram of the control valve phase shifter system 9. This hydraulic and control valve circuit 9 controls the phase shifter from critical pressures which produce system failure.

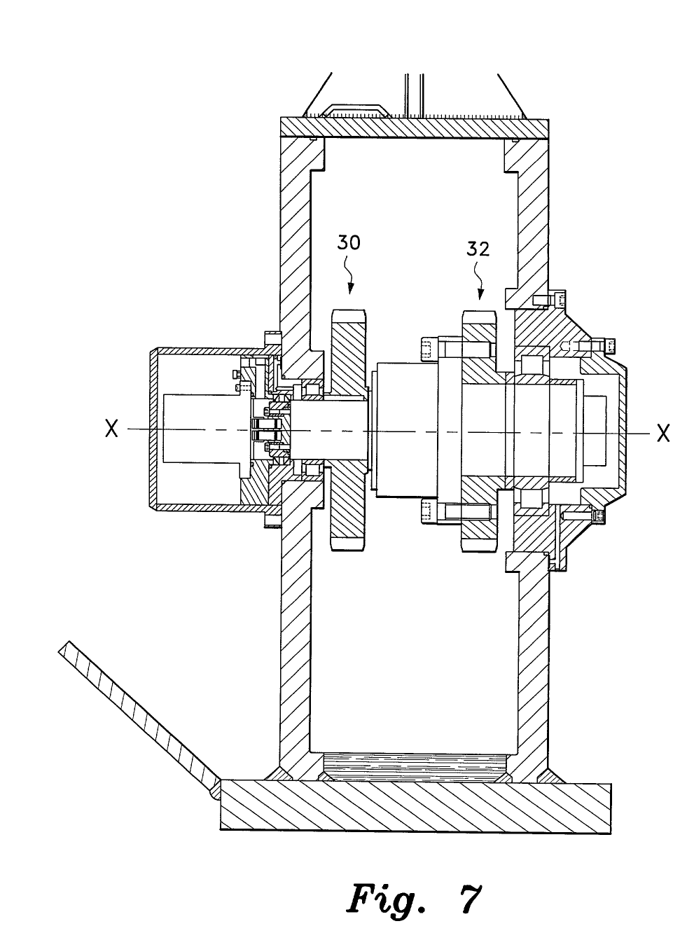

As diagrammatically illustrated in FIG. 7, the attached gears 30 and 32 are shown according to the alternate diaggrammatic view of FIG. 3A which, illustrates a single intermediate phase, wherein the phase shifter and gear assembly is mounted within a conventional variable moment vibrator housing assembly.

Other significant advantages of the variable moment vibrator according to the invention include wherein after the vibrator has reached its maximum operating frequency as determined by one having ordinary skill in the art, the phase shifter 7 will change the position of gears P3 and P4 and therefore the position of the eccentricities 11a and 11b, respectively to its normal operating position. Thus, during operation the phase shifter 7 can change the position of gears P3 and P4 in any desired position.

It is to be understood that the present invention is not limited to the embodiments described above, but encompasses any and all embodiments within the scope of the following claims.

We claim:

1. An improved variable moment vibrator driver system comprising:
a first set of gearwheels having at least one means for driving said first set of gearwheels, a second set of gearwheels having another at least one means for driving the second set of gearwheels, said at least one means and said another at least one means for driving the respective gears being decoupled respective driver means, and
a coupling means for selectively and dynamically coupling said first and second set of gears thereto with respective and selective first and second rotations.

2. The improved variable moment vibrator driver system according to claim 1, wherein said first set of gear wheels are each mounted on one eccentric first moment.

3. The improved variable moment vibrator driver system according to claim 1, wherein said second set of gear wheels are each mounted on one eccentric second moment.

4. The improved variable moment vibrator driver system according to claim 1, wherein said at least one driver means include a first drive gear and motor assembly for driving the first set of gear wheels.

5. The improved variable moment vibrator driver system according to claim 1, wherein said another at least one means include a second drive gear and motor assembly for driving the first set of gear wheels.

6. The improved variable moment vibrator driver system according to claim 1, wherein said coupling means is a phase shifter having first and second concentric shaft portion, wherein said first shaft portion includes an interior gear portion nested within an outer gear portion for selectively rotating said first shaft portion, about a central axis formed along the length of the shaft, the second shaft portion being of a smaller diameter than the first shaft portion.

7. The improved variable moment vibrator driver system according to claim 1, wherein said phase shifter comprises a first and second gear mounted thereto, said first gear being selectively and dynamically connected to the first set of gearwheels and said second gear being selectively and dynamically connected to the second set of gearwheels.

8. The improved variable moment vibrator driver system according to claim 1, wherein said phase shifter further comprises a hydraulic and control valve circuit for selectively controlling said phase shifter.
